(19) United States
(12) Patent Application Publication
(10) Pub. No.: US 2010/0040741 A1
(43) Pub. Date: Feb. 18, 2010

(54) Dyeing and/or Printing Formulations Comprising Monodisperse Particles

(76) Inventors: Michael Francis Butler, Sharnbrook (GB); Ramin Djalali, Sharnbrook (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/440,947

(22) PCT Filed: Aug. 28, 2007
(86) PCT No.: PCT/EP07/58939

§ 371 Date: Mar. 12, 2009

(30) Foreign Application Priority Data
Sep. 15, 2006 (EP) 06120787.4

(51) Int. Cl. C09D 11/00; C09D 11/10; B05D 5/06; A23P 1/00; B32B 3/00

(52) U.S. Cl. 426/87; 106/31.13; 524/599; 523/200; 524/590; 524/560; 106/31.6; 427/256; 427/288; 427/287; 426/383; 428/195.1; 428/210; 428/211.1

(57) ABSTRACT

The present invention relates to a printing formulation comprising monodisperse particles, at least one curing agent, at least one initiator and a solvent, as well as to the use of these formulations and to substances printed with these formulations.

The present invention relates to a printing formulation comprising monodisperse particles, at least one curing material, at least one initiator and a solvent, as well as to the use of these formulations for printing and to substances printed with these formulations.

Formulations for the inkjet technology comprising monodisperse particles are for example known from WO2005/063902.

The problem of such formulation is that when the monodisperse particles are printed on a substrate the stability of such a printing is weak. The printing can be damaged or even removed quiet easily. This can be demonstrated by a adhesive tape test.

Another problem occurs when curing is done during solvent evaporation, when the crosslinking occurs at normal or elevated temperature. Such a system can be found in WO2005/063902. This process is time consuming and the risk the printing suffers some damage is high, and the properties of the obtained printings are often not sufficient.

Therefore, the goal of the present patent application was to provide a formulation for a printing process comprising monodisperse particles which delivers a printed substrate with a good stability in a short time.

Surprisingly, it has been found out that due to the addition of at least one curing agent and at least one initiator, the quality of the obtained printing is improved as well as such a good printing is obtained fast.

The printing shows a better stability against mechanical influences (e.g. better scratch resistant); it shows a higher temperature resistance as well as an increased solvent resistance. Further more the monodisperse particles are less prone to oxidation, which leads to a longer lifetime of the printing.

And the time to get a printing of good overall properties is short.

In a first aspect, the present invention provides a printing formulation (PF I) comprising

(i) monodisperse particles,
(ii) at least one curing material,
(iii) at least one initiator, and
(iv) at least one solvent.

The monodisperse particles according to the present invention are capable of forming a colloidal crystal that diffracts light having a wavelength in a range that corresponds to the wavelength of visible light.

By the term “monodisperse particles” it is meant that all these particles in a formulation have the same size (diameter). A more comprehensive definition is given below.

The advantage of adding a separate curing agent and initiator (instead of a core/shell particle, wherein the shell forms a matrix system) is that any kind of curing agents and initiators can be used. Such a curing agent/initiator-system covers the gaps between each sphere in the layer arrangement in an excellent manner, so that even core/shell particles with a matrix forming shell get a better stabilisation and therefore a better printing quality is obtained.

Because of using an initiator the curing reaction takes place immediately and the printing is made stable in a fast manner.

The initiation process is started by an input of energy. Such energy can be in the form of heat, radiation (e.g. normal light, UV light), pressure etc.

Preferably the curing of the printing is done by (UV) light. In such a case the term “initiator” is equivalent to the term “photoinitiator”, which is a chemical that decompose with energy from UV or visible light.

Curing is a term in polymer chemistry and Process Engineering that refers to the toughening or hardening of a polymer material by cross-linking of polymer chains.

Processes for applying the formulation according to the present invention are commonly known process and they will be discussed below.

In a formulation according to the present invention the amount of monodisperse particles capable of forming a colloidal crystal that diffracts light having a wavelength in a range that corresponds to the wavelength of visible light can vary a lot. Depending whether the formulation is used as a concentrate which is to be diluted (with water and/or other solvents) or as a ready-to-use formulation. In the first case the amount of monodisperse particles is large, up to 70 weight-% (wt-%), based on the total weight of the printing formulation.

In the latter case the amount of the monodisperse particles can vary from 0.01 up to 30 wt-%, based on the total weight of the printing formulation.

It is obvious that the amount of the monodisperse particles also depend on the substrate which is to be printed as well as on the hue which needs to be obtained.

The present invention also relates to a concentrated printing formulation, wherein the amount of monodisperse particles lies between 30 wt-% and 70 wt-%, preferably between 30 wt-% and 60 wt-%, more preferably between 30 wt-% and 55 wt-%, based on the total weight of the printing formulation.

The present invention also relates to a printing formulation, wherein the amount of monodisperse particles lies between 0.01 wt-% and 30 wt-%, between 0.1 and 30 wt-%, more preferably between 0.1 and 20 wt-%, based on the total weight of the printing formulation.

It also to be stated that the amount of monodisperse particles can vary depending of the physical form of the formulation, that means the concentration can vary in case that the formulation is in liquid, gel, wax or paste form.

Monodisperse particles are defined as having at least 60% of the particles fall within a specified particle size range. Monodispersed particles deviate less than 10% in root mean square (rms) diameter. Highly monodisperse particles deviate less than 5% in rms diameter. Monodisperse particles for use in the invention typically have an rms diameter of less than about 1 μm and greater than about 1 nm, and are therefore classed as nanoparticles. Preferably the monodisperse particles have an rms diameter of greater than about 150 or about 200 nm. Preferably the monodisperse particles have an rms diameter of less than about 900 nm or about 800 nm. That means a usual diameter goes from 150 nm to 900 nm, preferably from 150 nm to 800 nm. More preferably the diameter of the monodisperse particles is from about 200 nm to about 550 nm.

The monodisperse particles are chosen such that they can form a colloidal crystal which appears coloured to the human eye, i.e. in the visible spectrum. The crystal colour or colours observed depend principally on two factors, namely the lattice spacing within the colloidal crystal and the refractive index of the particles and matrix, which affects the wavelength of light diffracted. The lattice spacing is determined by factors such as the size of the monodisperse particle. For example, we have used particles having a diameter of from 250 to 510 nm to generate coloured colloidal crystals having colours ranging from blue and red to green and yellow. Colloidal crystals can have different colours when viewed from different angles because the lattice spacing can be different in different axes of the crystal. Provided that the lattice spacing in at least one axis results in diffraction of light with a wavelength in the visible spectrum then the crystal will appear to be coloured.

Monodisperse particles can be of varying geometry. In a preferred embodiment, the monodisperse particles are substantially spherical.

In another preferred embodiment of the present invention the monodisperse particles are spherical.

In another preferred embodiment of the present invention the monodisperse particles are inorganic.

In another preferred embodiment of the present invention the monodisperse particles are organic polymers.

Preferably, the lattice spacing in at least one axis is from about 350 to about 780 nm, preferably from 380 to 770 nm.

The monodisperse particles suitable for use in the colorant compositions of the present invention may be made from any suitable material, including one or more selected from organic and/or inorganic materials. For example, suitable organic materials include organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles. Suitable inorganic materials include metal chalcogenide, metal pnictide, silica, metal and metal oxide particles. Examples of suitable metal oxides include, for example, Al₂O₃, TiO₂, SnO₂, Sb₂O₅, Fe₂O₃, ZrO₂, CeO₂ and Y₂O₃. Examples of suitable metals include, for example, gold, copper and silver.

By the term “metal chalcogenide” we mean metal compounds formed with anions from group 16 of the Periodic Table of Elements (according to established IUPAC nomenclature), i.e. oxygen, sulphur, selenium, tellurium and polonium.

By the term “metal pnictide” we mean metal compounds formed with anions from group 15 of the Periodic Table of Elements (according to established IUPAC nomenclature), i.e. nitrogen, phosphorus, arsenic, antimony and bismuth.

Monodispersed poly(methylmethacrylate) composites may be prepared following the process described by M. Egen, R. Zentel (Macromol. Chem. Phys. 2004, 205, 1479-1488) or are commercially available from Duke Scientific Corporation.

Methods for preparing monodisperse particles are known in the art. Dispersions may be prepared using emulsion, dispersion, suspension polymerization if particles are polymeric, or if particles are inorganic (e.g., silica particles) the dispersion may be prepared using sol-gel processes.

Monodispersed silica spheres can be prepared following the well-known process by Stöber, Fink and Bohn (J. Colloid Interface Sci. 1968, 26, 62). The process was later refined by Bogush, et. al. (J. Non-Crys. Solids 1988, 104, 95). Alternatively, silica particles can be purchased from Blue Helix, Limited or they can be freshly prepared by the process described in U.S. Pat. No. 4,775,520 and U.S. Pat. No. 4,911,903.

For example, monodisperse silica spheres can be produced by hydrolytic polycondensation of tetraalkoxysilanes in an aqueous-ammoniacal medium, a sol of primary particles being produced first of all and then the silica particles obtained being brought to the desired particle size by continuous, controlled addition of tetraalkoxysilane. With this process it is possible to produce monodisperse SiO₂ spheres having average particle diameters of between 0.05 and 10 μm with a standard deviation of less than 7%.

The formulations according to the present invention comprise monodisperse particles capable of forming a colloidal crystal, for example upon application of the colorant composition to a substrate.

For the avoidance of doubt, references herein to “a colloidal crystal” are intended to relate to one or more colloidal crystals.

By the term “colloidal crystal” we mean a regular array of monodisperse particles having a substantially regular or constant spacing there between. Thus, the array of monodisperse particles forms a dispersed phase arranged in a continuous phase (or matrix). The continuous phase (or matrix) may comprise a gas, a liquid or a solid of a different refractive index to the dispersed phase.

As the skilled person would appreciate, a colloidal crystal may, however, contain some impurities and/or defects. The levels of impurities and/or defects typically will depend on the materials and methods of preparation used.

The term “colloidal crystal” has the same meaning as the term “super-lattice”. A colloidal crystal or super-lattice is a type of photonic crystal, which is an optical, artificial structure characterised by 2D or 3D periodic arrangements of dielectric material which lead to the formation of energy band structures for electromagnetic waves propagating them. Preferably the colloidal crystal has a lattice spacing in a range that corresponds to the wavelength of visible light.

In a preferred embodiment the colloidal crystal has a lattice spacing in a range that corresponds to the wavelength of visible light.

The present invention also relates to a printing formulation

(PF Ia) comprising
(i) monodisperse particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles; inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
(ii) at least one curing material, and
(iii) at least one initiator, and
(iv) at least one solvent.

Preferred are printing formulations wherein inorganic materials are used. Such materials are not only (UV) light resistant but they are also more stable to elevated temperature. Elevated temperature can be used (depending on the solvent of the formulation) to get rid of the solvent during or after the printing process.

The present invention also relates to a printing formulation

(PF Ib) comprising
(i) monodisperse particles, chosen from the group consisting inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
(ii) at least one curing material, and
(iii) at least one initiator, and
(iv) at least one solvent.

The monodisperse particles of printing formulations (PFIa) and (PFIb) deviate less than 10% in root mean square (rms) diameter, preferably less than 5% in rms diameter and they have a diameter from 150 nm to 900 nm, preferably from 150 nm to 800 nm, more preferably the diameter of the monodisperse particles is from about 200 nm to about 550 nm.

The printing formulation comprises at least one solvent.

Preferably the solvent is an organic solvent, which can be polar or nonpolar. Examples of polar solvents include water, alcohols (mono or poly), esters, ketones and ethers, particularly mono- and di-alkyl ethers of glycols and polyglycols such as monomethyl ethers of mono-, di- and tri-propylene glycols and the mono-n-butyl ethers of ethylene, diethylene and triethylene glycols.

Examples of nonpolar solvents include aliphatic and aromatic hydrocarbons having at least six carton atoms and mixtures thereof including refinery distillation products and by-products.

The printing formulation can be prepared as an aqueous or as a non-aqueous solution. Therefore, another embodiment of the present invention related to a printing formulation as described above, wherein the formulation is nonaqueous.

Therefore, another embodiment of the present invention relates to a printing formulation as described above, wherein the formulation is aqueous.

Therefore, the present invention also relates to a printing formulation (PF II) comprising

(i) monodisperse particles, and
(ii) at least one curing material, and
(iii) at least one initiator, and
(iva) water, and
(iva) optionally at least one solvent, chosen from the group consisting of alcohols, esters, ketones, ethers and aliphatic and aromatic hydrocarbons having at least six carton atoms and mixtures thereof including refinery distillation products and by-products.

Therefore, the present invention also relates to a printing formulation (PF IIa) comprising
(i) monodisperse particles, and
(ii) at least one curing material, and
(iii) at least one initiator, and
(iv) at least one solvent, chosen from the group consisting of alcohols, esters, ketones, ethers and aliphatic and aromatic hydrocarbons having at least six carton atoms and mixtures thereof including refinery distillation products and by-products.

The monodisperse particles of printing formulations (PFII) and (PFIIa) deviate less than 10% in root mean square (rms) diameter, preferably less than 5% in rms diameter and they have a diameter from 150 nm to 900 nm, preferably from 150 nm to 800 nm, more preferably the diameter of the monodisperse particles is from about 200 nm to about 550 nm.

In a preferred embodiment, the solvent can be chosen from water; alcohols, such as ethanol, methanol, propanol, butanol; esters; ketones; and ethers, particularly mono- and di-alkyl ethers of glycols and polyglycols such as monomethyl ethers of mono-, di- and tri-propylene glycols and the mono-n-butyl ethers of ethylene, diethylene and triethylene glycols.

But, even when no water is deliberately added to the nonaqueous vehicle, some adventitious water may be carried into the formulation, but generally this will be no more than about 2-4 wt-%, based on the total weight of the printing formulation. By definition, the nonaqueous ink of this invention will have no more than about 10%, and preferably no more than about 5 wt-% water, based on the total weight of the printing formulation.

The amount of solvent in the printing formulation is typically in the range of about 10 to about 99.99 wt-%, preferably from about 20 to about 99.9 wt-%, and more preferably from about 30 to about 99.9 wt-%, based on the total weight of the printing formulation.

The amount of solvent which is part of the inventive formulation can very a lot. The reasons for that are the same as explained for the monodisperse particles above.

When the formulation is used as a concentrate then the amount of solvents is low, usually between 30 and 70 wt-%, based on the total weight of the printing formulation. In certain cases the printing formulation can comprise even less that 30 wt-%.

When the formulation is in a ready-to-use form then the solvent content can be up to 99.99 wt-%, based on the total weight of the printing formulation.

It is obvious that the amount solvent also depend on the substrate which is to be printed as well as on the hue which needs to be obtained.

Therefore, the present invention also relates to a concentrated printing formulation, wherein the amount of solvent lies between 30 wt-% and 70 wt-%, preferably between 35 wt-% and 70 wt-%, more preferably between 35 wt-% and 65 wt-%, based on the total weight of the printing formulation.

The present invention also relates to a printing formulation, wherein the amount of water lies between 70 wt-% and 99.99 wt-%, preferably between 70 wt-% and 99.9 wt-%, more preferably between 80 wt-% and 99.9 wt-%, based on the total weight of the printing formulation.

The formulations which comprise water (pure aqueous as well as water/solvent-mixtures) are preferred.

It also to be stated that the amount of monodisperse particles as well as of the solvent can vary depending of the physical form of the formulation, that means the concentration can vary in case the printing formulation is a liquid, gel or a paste.

The formulation according to the present invention also comprises at least one curing agent. A curing agent has good mechanical, adhesive and thoughness properties as well as good resistance to environmental degradation. The curing agents can be classified into two main groups the “thermoplastic” and “thermosetting” types. Any kind of commonly know curing agent can be used. Usually curing agent are resins which are crosslinkable. These are low molecular or oligomeric polyfunctional compounds with a molecular mass <1000 g/mol. The functional groups which are often terminal groups (for example epoxy-, isocyanate-, amine- or hydroxy-groups) are chose that way (amount of groups as well as kind of the groups) that the react according to the polyaddition or polycondensation mechanism.

Suitable curing agents are polyester, vinylester and epoxy compounds. Furthermore phenolic, cyanate ester, polyurethane, bismaleimide, polyimide, epoxy acrylate, polyurethane acrylate, polyester acrylate, acrylated polyol and acrylated polyether compounds can be used as well.

Curing agents are well known and can be bought commercially for examples from BASF, from Jenton International UK, or from ALBERDINGK.

Therefore a further preferred embodiment of the present invention relates to a printing formulation, wherein the curing agent is chosen from the group consisting of polyester, vinylester, epoxy, phenolic, cyanate esters, polyurethanes, bismaleimides, polyimides, epoxy acrylates, polyurethane acrylates, polyester acrylates, acrylated polyols and acrylated polyether compounds.

Such curing agents are used in an amount of 0.01 wt-%-15 wt-%, based on the total weight of the printing formulation. Preferably, curing agents are present in an amount of 0.1-10 wt-%, based on the total weight of the printing formulation.

In combination with the curing agent(s) at least one initiator is used. This initiator is which starts the polymerisation of the curing agent.

When the initiation takes place with radiation, it is usually done by exposition to light (400 nm—800 nm) and/or UV-light (100 nm-400 nm) and/or IR (800 nm-1400 nm).

Such an initiator can be peroxide or peroxide containing compounds, benzophenone and benzophenone derivatives, acetophenone and acetophenone derivatives, benzoin ether derivatives and thioxanthones derivatives.

Therefore a further preferred embodiment of the present invention relates to a printing formulation, wherein the initiator is chosen from the group consisting of peroxide or peroxide containing compounds, benzophenone and benzophenone derivatives, acetophenone and acetophenone derivatives, benzoin ether derivatives and thioxanthones derivatives.

Further suitable initiators are α-hydroxyketone, phenylglyoxylate, benzyldimethyl-ketal, α-aminoketone, mono acyl phospine, bis acyl phosphine, phosphine oxide, metallocene, iodinum salts.

Such initiators are well known and are available for examples from BASF (Lucricin®) or Ciba Specialty Chemicals (IRGACURE® range: IRGACURE® 184, IRGACURE® 500, IRGACURE® 2959, IRGACURE® 754, IRGACURE® 651, IRGACURE® 369, IRGACURE® 907, IRGACURE® 1300, IRGACURE® 819, IRGACURE® 819DW, IRGACURE® 2022, IRGACURE® 2100, IRGACURE® 784, IRGACURE® 250 as well as the DAROCUR® range: DAROCUR® 1173, DAROCUR® MBF, DAROCUR® TPO and DAROCUR® 4265).

Such initiators are used in an amount of 0.005 wt-%-10 wt-%, based on the total weight of the printing formulation. Preferably, initiators are present in an amount of 0.01-8 wt-%, based on the total weight of the printing formulation.

Therefore, the present invention provides a printing formulation (PF II) comprising
(i) 0.01 wt-% to 70 wt-%, based on the total weight of the formulation, of monodisperse particles, and
(ii) 0.01 wt-% to 15 wt-%, based on the total weight of the formulation, of at least one curing material, and
(iii) 0.005 wt-% to 10 wt-%, based on the total weight of the formulation, of at least one initiator, and
(iv) 10 wt-% and 99.99 wt-%, based on the total weight of the formulation, of at least one solvent.

Therefore, the present invention provides a printing formulation (PF IIIa) comprising
(i) 0.01 wt-% to 70 wt-%, based on the total weight of the formulation, monodisperse particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles; inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
(ii) 0.01 wt-% to 15 wt-%, based on the total weight of the formulation, of at least one curing material, and
(iii) 0.005 wt-% to 10 wt-%, based on the total weight of the formulation, of at least one initiator, and
(iva) 10 wt-% and 99.99 wt-%, based on the total weight of the formulation of water, and
(ivb) optionally 0.1 wt-% and 89.99 wt-%, based on the total weight of the formulation of at least one solvent, chosen from the group consisting of alcohols, esters, ketones, ethers and aliphatic and aromatic hydrocarbons having at least six carton atoms and mixtures thereof including refinery distillation products and by-products.

Therefore, the present invention provides a printing formulation (PF IIIa′) comprising
(i) 0.01 wt-% to 70 wt-%, based on the total weight of the formulation, of monodisperse particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethyl methacrylate) particles; inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and (ii) 0.01 wt-% to 15 wt-%, based on the total weight of the formulation, of at least one curing material chosen from the group consisting of polyester, vinylester, epoxy, phenolic, cyanate ester, polyurethane, bismaleimide, polyimide, epoxy acrylate, polyurethane acrylate, polyester acrylate, acrylated polyol and acrylated polyether compounds, and
(iii) 0.005 wt-% to 10 wt-%, based on the total weight of the formulation, of at least one initiator chosen from the group consisting of peroxide or peroxide containing compounds, benzophenone and benzophenone derivatives, acetophenone and acetophenone derivatives, benzoin ether derivatives, thioxanthones derivatives α-hydroxyketone, phenylglyoxylate, benzyldimethyl-ketal, α-aminoketone, mono acyl phospine. bis acyl phosphine, phosphine oxide, metallocene, iodinum salts, and
(iva) 10 wt-% and 99.99 wt-%, based on the total weight of the formulation, of water, and
(ivb) optionally 0.1 wt-% and 89.99 wt-%, based on the total weight of the formulation of at least one solvent, chosen from the group consisting of alcohols, esters, ketones, ethers and aliphatic and aromatic hydrocarbons having at least six carton atoms and mixtures thereof including refinery distillation products and by-products.

Therefore, the present invention provides a printing formulation (PF IIIb) comprising
(i) 0.01 wt-% to 70 wt-%, based on the total weight of the formulation, of monodisperse particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles; inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
(ii) 0.01 wt-% to 15 wt-%, based on the total weight of the formulation, of at least one curing material, and
(iii) 0.005 wt-% to 10 wt-%, based on the total weight of the formulation, of at least one initiator, and
(iv) 10 wt-% and 99.99 wt-%, based on the total weight of the formulation, of at least one solvent, chosen from the group consisting of alcohols, esters, ketones, ethers and aliphatic and aromatic hydrocarbons having at least six carton atoms and mixtures thereof including refinery distillation products and by-products.

Therefore, the present invention provides a printing formulation (PF IIIb′) comprising
(i) 0.01 wt-% to 70 wt-%, based on the total weight of the formulation, of monodisperse particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethyl methacrylate) particles; inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
(ii) 0.01 wt-% to 15 wt-%, based on the total weight of the formulation, of at least one curing material chosen from the group consisting of polyester, vinylester, epoxy, phenolic, cyanate ester, polyurethane, bismaleimide, polyimide, epoxy acrylate, polyurethane acrylate, polyester acrylate, acrylated polyol and acrylated polyether compounds, and
(iii) 0.005 wt-% to 10 wt-%, based on the total weight of the formulation, of at least one initiator chosen from the group consisting of peroxide or peroxide containing compounds, benzophenone and benzophenone derivatives, acetophenone and acetophenone derivatives, benzoin ether derivatives, thioxanthones derivatives α-hydroxyketone, phenylglyoxylate, benzyldimethyl-ketal, α-aminoketone, mono acyl phospine. bis acyl phosphine, phosphine oxide, metallocene, iodinum salts, and
(iv) 10 wt-% and 99.99 wt-%, based on the total weight of the formulation, of at least one solvent, chosen from the group consisting of alcohols, esters, ketones, ethers and aliphatic and aromatic hydrocarbons having at least six carton atoms and mixtures thereof including refinery distillation products and by-products.

Most preferred are formulations which comprise water (pure aqueous as well as water/solvent-mixtures), at least one curing agent and at least one photoinitiator (for light, UV or IR).

The monodisperse particles of printing formulations (PF III), (PF IIIa), (PF IIIa′), (PF IIIb) and (PF IIIb′) deviate less than 10% in root mean square (rms) diameter, preferably less than 5% in rms diameter and they have a diameter from 150 nm to 900 nm, preferably from 150 nm to 800 nm, more preferably the diameter of the monodisperse particles is from about 200 nm to about 550 nm.

All the preferences for the components (i), (ii), (iii), (iv), (iva) and (ivb) regarding the compounds and the amount which are disclosed above can all be applied to these formulations (PF II), (PF IIIa), (PF IIIa′), (PF IIIb) and (PF IIIb′).

Additionally a printing formulation can comprise further auxiliaries. Such auxiliaries are these commonly used in the field of printing.

Auxiliaries are those additional chemicals which are used along with the dyes, to fix the dyes to the fabric or otherwise improve our results of the printing process. Furthermore, under the term auxiliaries is to be understood the chemicals, which help to improve the property of the formulation itself, such as storage, better manipulability of the formulation, etc.

Examples of auxiliaries are for examples pigments (such as titanium dioxide or carbon black), fillers (such as barytes, calcite, mica, talc, whiting, and wollastonite), extenders, (such as aluminum silicate), degassing agents, dry flow agents, flow agents (such as polyacrylates, silicones, surfactants, and fluorinated alkyl esters), matting agents, texturing agents, rheological additives, coalescence agents and waxes.

Such auxiliaries are usually present in a smaller amount, which can go up to about 10 wt-%, based on the total weight of the printing formulation.

If one or more auxiliaries are present the amount goes usually from 0.1 wt-% to 10 wt-%.

Therefore a further embodiment of the present invention relates to a printing formulation as described above comprising additionally at least one auxiliary. Therefore a further embodiment of the present invention relates to a printing formulation (PF IV) comprising
(i) monodisperse particles, and
(ii) at least one curing material, and
(iii) at least one initiator, and
(iv) at least one solvent, and
(v) at least one auxiliary.

Therefore a further embodiment of the present invention relates to a printing formulation (PF V) comprising
(i) monodisperse particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethyl methacrylate) particles; inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
(ii) at least one curing material, and
(iii) at least one initiator, and
(iv) at least one solvent, and
(v) at least one auxiliary.

Therefore a further embodiment of the present invention relates to a printing formulation (PF VI) comprising
(i) monodisperse particles, and
(ii) at least one curing material, and
(iii) at least one initiator, and
(iv) at least one further solvent, and
(v) at least one auxiliary chosen from the group consisting of pigments (such as titanium dioxide or carbon black), fillers (such as barytes, calcite, mica, talc, whiting, and wollastonite), extenders, (such as aluminum silicate), degassing agents, dry flow agents, flow agents (such as polyacrylates, silicones, surfactants, and fluorinated alkyl esters), matting agents, texturing agents, rheological additives, coalescence agents and waxes.

Therefore a further embodiment of the present invention relates to a printing formulation (PF VII) comprising
(i) monodisperse particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles; inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
(ii) at least one curing material, and
(iii) at least one initiator, and
(iv) at least one further solvent, and
(v) at least one auxiliary chosen from the group consisting of pigments (such as titanium dioxide or carbon black), fillers (such as barytes, calcite, mica, talc, whiting, and wollastonite), extenders, (such as aluminum silicate), degassing agents, dry flow agents, flow agents (such as polyacrylates, silicones, surfactants, and fluorinated alkyl esters), matting agents, texturing agents, rheological additives, coalescence agents and waxes.

Another embodiment of the present invention relates to a printing formulation (PF VIII) comprising
(i) 0.01 wt-% to 70 wt-%, based on the total weight of the formulation, of monodisperse particles, and
(ii) 0.01 wt-% to 15 wt-%, based on the total weight of the formulation, of at least one curing material, and
(iii) 0.005 wt-% to 10 wt-%, based on the total weight of the formulation, of at least one initiator, and
(iv) 10 wt-% and 99.99 wt-%, based on the total weight of the formulation, of at least one solvent, and
(v) 0.1 wt-% to 10 wt-%, based on the total weight of the formulation, of at least one auxiliary.

Another embodiment of the present invention relates to a printing formulation (PF IX) comprising
(i) 0.01 wt-% to 70 wt-%, based on the total weight of the formulation, of monodisperse particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethyl methacrylate) particles; inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
(ii) 0.01 wt-% to 15 wt-%, based on the total weight of the formulation, of at least one curing material, and
(iii) 0.005 wt-% to 10 wt-%, based on the total weight of the formulation, of at least one initiator, and
(iv) 10 wt-% and 99.99 wt-%, based on the total weight of the formulation, of at least one solvent, and
(v) 0.1 wt-% to 10 wt-%, based on the total weight of the formulation, of at least one auxiliary.

Another embodiment of the present invention relates to a printing formulation (PF X) comprising
(i) 0.01 wt-% to 70 wt-%, based on the total weight of the formulation, of monodisperse particles, and
(ii) 0.01 wt-% to 15 wt-%, based on the total weight of the formulation, of at least one curing material, and
(iii) 0.005 wt-% to 10 wt-%, based on the total weight of the formulation, of at least one initiator, and
(iv) 10 wt-% and 99.99 wt-%, based on the total weight of the formulation, of at least one further solvent, and
(vi) 0.1 wt-% to 10 wt-%, based on the total weight of the formulation, at least one auxiliary chosen from the group consisting of pigments (such as titanium dioxide or carbon black), fillers (such as barytes, calcite, mica, talc, whiting, and wollastonite), extenders, (such as aluminum silicate), degassing agents, dry flow agents, flow agents (such as polyacrylates, silicones, surfactants, and fluorinated alkyl esters), matting agents, texturing agents, rheological additives, coalescence agents and waxes.

Another embodiment of the present invention relates to a printing formulation (PF Xl) comprising
(i) 0.01 wt-% to 70 wt-%, based on the total weight of the formulation, of monodisperse particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethyl methacrylate) particles; inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
(ii) 0.01 wt-% to 15 wt-%, based on the total weight of the formulation, of at least one curing material, and
(iii) 0.005 wt-% to 10 wt-%, based on the total weight of the formulation, of at least one initiator, and
(iv) 10 wt-% and 99.99 wt-%, based on the total weight of the formulation, of at least one solvent, and
(v) 0.1 wt-% to 10 wt-%, based on the total weight of the formulation, of at least one auxiliary chosen from the group consisting of pigments (such as titanium dioxide or carbon black), fillers (such as barytes, calcite, mica, talc, whiting, and wollastonite), extenders, (such as aluminum silicate), degassing agents, dry flow agents, flow agents (such as polyacrylates, silicones, surfactants, and fluorinated alkyl esters), matting agents, texturing agents, rheological additives, coalescence agents and waxes.

Another embodiment of the present invention relates to a printing formulation (PF XIa) comprising
(i) 0.01 wt-% to 70 wt-%, based on the total weight of the formulation, of monodisperse particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles; inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
(ii) 0.01 wt-% to 15 wt-%, based on the total weight of the formulation, of at least one curing material chosen from the group consisting of polyester, vinylester, epoxy, phenolic, cyanate ester, polyurethane, bismaleimide, polyimide, epoxy acrylate, polyurethane acrylate, polyester acrylate, acrylated polyol and acrylated polyether compounds, and
(iii) 0.005 wt-% to 10 wt-%, based on the total weight of the formulation, of at least one initiator chosen from the group consisting of peroxide or peroxide containing compounds, benzophenone and benzophenone derivatives, acetophenone and acetophenone derivatives, benzoin ether derivatives, thioxanthones derivatives α-hydroxyketone, phenylglyoxylate, benzyldimethyl-ketal, α-aminoketone, mono acyl phospine. bis acyl phosphine, phosphine oxide, metallocene, iodinum salts, and
(iva) 10 wt-% and 99.99 wt-%, based on the total weight of the formulation, of water, and
(ivb) optionally 0.1 wt-% and 89.99 wt-%, based on the total weight of the formulation of at least one solvent, chosen from the group consisting of alcohols, esters, ketones, ethers and aliphatic and aromatic hydrocarbons having at least six carton atoms and mixtures thereof including refinery distillation products and by-products, and
(v) 0.1 wt-% to 10 wt-%, based on the total weight of the formulation, of at least one auxiliary chosen from the group consisting of pigments (such as titanium dioxide or carbon black), fillers (such as barytes, calcite, mica, talc, whiting, and wollastonite), extenders, (such as aluminum silicate), degassing agents, dry flow agents, flow agents (such as polyacrylates, silicones, surfactants, and fluorinated alkyl esters), matting agents, texturing agents, rheological additives, coalescence agents and waxes.

Another embodiment of the present invention relates to a printing formulation (PF XIb) comprising
(i) 0.01 wt-% to 70 wt-%, based on the total weight of the formulation, of monodisperse particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethyl methacrylate) particles; inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
(ii) 0.01 wt-% to 15 wt-%, based on the total weight of the formulation, of at least one curing material chosen from the group consisting of polyester, vinylester, epoxy, phenolic, cyanate ester, polyurethane, bismaleimide, polyimide, epoxy acrylate, polyurethane acrylate, polyester acrylate, acrylated polyol and acrylated polyether compounds, and
(iii) 0.005 wt-% to 10 wt-%, based on the total weight of the formulation, of at least one initiator chosen from the group consisting of peroxide or peroxide containing compounds, benzophenone and benzophenone derivatives, acetophenone and acetophenone derivatives, benzoin ether derivatives, thioxanthones derivatives α-hydroxyketone, phenylglyoxylate, benzyldimethyl-ketal, α-aminoketone, mono acyl phospine. bis acyl phosphine, phosphine oxide, metallocene, iodinum salts, and
(iv) 10 wt-% and 99.99 wt-%, based on the total weight of the formulation, of at least one solvent, chosen from the group consisting of alcohols, esters, ketones, ethers and aliphatic and aromatic hydrocarbons having at least six carton atoms and mixtures thereof including refinery distillation products and by-products, and
(v) 0.1 wt-% to 10 wt-%, based on the total weight of the formulation, of at least one auxiliary chosen from the group consisting of pigments (such as titanium dioxide or carbon black), fillers (such as barytes, calcite, mica, talc, whiting, and wollastonite), extenders, (such as aluminum silicate), degassing agents, dry flow agents, flow agents (such as polyacrylates, silicones, surfactants, and fluorinated alkyl esters), matting agents, texturing agents, rheological additives, coalescence agents and waxes.

The monodisperse particles of printing formulations (PF IV), (PF V), (PF VI), (PF VII), (PF VIII), (PF IX), (PF X), (PF XI), (PF XIa) and/or (PF XIb) deviate less than 10% in root mean square (rms) diameter, preferably less than 5% in rms diameter and they have a diameter from 150 nm to 900 nm, preferably from 150 nm to 800 nm, more preferably the diameter of the monodisperse particles is from about 200 nm to about 550 nm.

As already mentioned the formulation according to the present invention can be in any suitable physical form. Usually it is in the form of a liquid, a gel or a paste.

It is to be said as well once again that the water content and the content of the monodisperse particles can vary dependent whether a concentrated formulation or a ready to use (diluted) formulation is provided.

The invention also relates to the use of a formulation (PF I), (PF Ia), (PF Ib), (PF II), (PF IIa), (PF III), (PF IIIa), (PF IIIa′), (PF IIIb), (PF IIIb′), (PF IV), (PF V), (PF VI), (PF VII), (PF VIII), (PF IX), (PF X), (PF XI), (PF XIa) and/or (PF XIb) for printing a substrate, which method comprises contacting the substrate with a composition comprising monodisperse particles capable of forming a colloidal crystal that diffracts light having a wavelength in a range that corresponds to the wavelength of visible light, such that colloidal crystals comprising the monodisperse particles form on the substrate.

The printing process can be done according to well known processes such as Ink jet (such as Bubble Jet, Compound jet, Dry Inkjet, Hotmelt Inkjet), rollercoating, relief printing, intaglio, letterpress, lithography, flexography, gravure, screen printing, pad printing, etc. . . .

Depending what kind of process will be used the formulation can be adapted by adding the necessary amount of additives to obtain the desired properties.

The formulations according to the present invention can be applied to any suitable substrate.

The printing process also comprises the step of curing by any kind of energy input. It is usually done by heat, radiation (e.g. normal light or UV light) or pressure. Combination of these energy sources are also possible.

The substrate is preferably exposed to light (400 nm-800 nm) and/or UV-light (100 nm-400 nm) and/or IR (800 nm-1400 nm) during the application of the printing formulations as described above and/or afterwards.

Preferred substrates are those with surface irregularities that act as sites for crystal nucleation. Substrates include fibre (such as hair), skin, nails, food material, stone, ceramic, glass, paper, fabrics, wood, leather and plastics.

A fibre is a fine hair-like structure of biological, mineral or synthetic origin. In the context of the present invention, fibres include animal or human hair. The fibres may be part of a fabric, such as a textile or nonwoven fabric.

Commercially available fibres have diameters ranging from less than about 0.001 mm to more than about 0.2 mm and they come in several different forms: short fibres (known as staple, or chopped), continuous single fibres (filaments or monofilaments), untwisted bundles of continuous filaments (tow), and twisted bundles of continuous filaments (yarn). Fibres are classified according to their origin, chemical structure, or both. They can be braided into ropes and cordage, made into felts (also called nonwovens or nonwoven fabrics), woven or knitted into textile fabrics, or, in the case of high-strength fibres, used as reinforcements in composites.

Fibres may be natural fibres, synthetic or man-made fibres, or combinations thereof. Examples of natural fibres include but are not limited to: animal fibres such as wool, silk, fur, and hair; vegetable fibres such as cellulose, cotton, flax, linen, and hemp; and certain naturally occurring mineral fibres. Synthetic fibres can be derived from natural fibres or not. Examples of synthetic fibres which are derived from natural fibres include but are not limited to rayon and lyocell, both of which are derived from cellulose, a natural polysaccharide fibre. Synthetic fibres which are not derived from natural fibres can be derived from other natural sources or from mineral sources. Examples of synthetic fibres derived from natural sources include polysaccharides such as starch. Examples of fibres from mineral sources include but are not limited to polyolefin fibres such as polypropylene and polyethylene fibres, which are derived from petroleum, and silicate fibres such as glass and asbestos. Synthetic fibres are commonly formed, when possible, by fluid handling processes (e.g., extruding, drawing, or spinning a fluid such as a resin or a solution). Synthetic fibres are also formed by solid handling size reduction processes (e.g., mechanical chopping or cutting of a larger object such as a monolith, a film, or a fabric).

Common synthetic fibres include but are not limited to nylon (polyamide), acrylic (polyacrylonitrile), aramid (aromatic polyamide), polyolefin (polyethylene and polypropylene), polyester and butadiene-stryene block copolymers.

Preferably the invention also relates to the use of a formulation (PF I), (PF Ia), (PF II), (PF IIa), (PF II), (PF IIIa), (PF IIIa′), (PF IIIb), (PF IIIb′), (PF IV), (PF V), (PF VI), (PF VII), (PF VIII), (PF IX), (PF X), (PF XI), (PF XIa) and/or (PF XIb) for printing a substrate chosen from the group consisting of fibre (such as hair), skin, nails, food material, stone, ceramic, glass, paper, fabrics, wood, leather and plastics.

A method of colouring a substrate selected from hair of an individual and fabric fibres, which method comprises contacting the substrate with a composition comprising monodisperse particles capable of forming a colloidal crystal that diffracts light having a wavelength in a range that corresponds to the wavelength of visible light, such that colloidal crystals comprising the monodisperse particles form on the substrate. Fibre colorant compositions of the invention can be used to colour the fibres in a fabric. Colouring of fibres also includes the ‘brightening’ of fibres, such in the case of white textile materials.

Fibres can be coloured by contacting the fibres, such as the hair of an individual or fabric fibres, with a composition of the invention. Hair colorant compositions are typically in the form of sprays, lotions, shampoos, creams or pastes which can be applied directly to all or part of the hair. Following a suitable contact time, excess composition can then be washed off if necessary. Preferably the composition is in contact with the hair for sufficient time such that at least two or three layers of colloidal crystals are formed.

Fibre colorant compositions for use in colouring or brightening fabrics/textiles can be applied as part of standard laundry formulations known in the art such as powders or tablets that dissolve/disperse in water or as liquids.

Ink compositions of the invention can be applied to substrates using standard printing techniques known in the art for applying inks to a range of substrates. Typically, the ink compositions are applied the substrate to form letters, numerals or other symbols, or graphic designs.

In the above applications, it is sufficient for a single layer of colloidal crystals to form on or within the substrate or fibre. However, it is preferred that at least two or three layers of colloidal crystals are formed. The coverage of colloidal crystalline layers need not be complete i.e. it can be a discontinuous layer. Depending on the substrate, which may be porous, colloidal crystals may form on the surface of, and/or within, the substrate. Further, the crystalline layer or layers need not be entirely regular, provided that the desired colour effects are achieved. In other words some crystal disorder is permitted.

Preferably, the formulation according to the present invention is applied to form letters, numbers or other symbols, or a graphic design on the substrate.

In one embodiment, the formulation according to the present invention is a hair colorant composition. In another embodiment the formulation according to the present invention is a textile colorant composition. In a further embodiment, formulation according to the present invention is an ink composition, i.e. suitable for printing onto a printable surface such as paper or fabrics.

In a related aspect the present invention provides a method of printing onto a substrate which method comprises contacting at least a region of the substrate with a formulation according to the present invention comprising monodisperse particles capable of forming a colloidal crystal having a lattice spacing in a range that corresponds to the wavelength of visible light, such that colloidal crystals comprising the monodisperse particles form on at least a portion of the substrate.

In a related aspect the present invention provides use of a formulation according to the present invention comprising monodisperse particles capable of forming a colloidal crystal that diffracts light having a wavelength in a range that corresponds to the wavelength of visible light, in the manufacture of a product for colouring the hair of an individual.

Similarly, the invention provides use of a formulation according to the present invention comprising monodisperse particles capable of forming a colloidal crystal that diffracts light having a wavelength in a range that corresponds to the wavelength of visible light, in the manufacture of a product for colouring the fibres in a fabric.

Yet another aspect of the invention provides use of a formulation according to the present invention comprising monodisperse particles capable of forming a colloidal crystal that diffracts light having a wavelength in a range that corresponds to the wavelength of visible light, in the manufacture of an ink.

The invention also relates to a substrate comprising at least one colloidal crystalline layer comprising monodisperse particles, which layer diffracts light having a wavelength in a range that corresponds to the wavelength of visible light.

The invention also relates to a substrate, chosen from the group consisting of fibre (such as hair), skin, nails, food material, stone, ceramic, glass, paper, fabrics, wood, leather and plastics, comprising at least one colloidal crystalline layer comprising monodisperse particles, which layer diffracts light having a wavelength in a range that corresponds to the wavelength of visible light.

The present invention also provides a fibrous material comprising, typically thereon or within, at least one colloidal crystalline layer comprising monodisperse particles, which layer diffracts light having a wavelength in a range that corresponds to the wavelength of visible light. In one embodiment, the fibrous material is a fabric. Preferably, the fibrous material comprises at least two or three layers of the colloidal crystals.

The present invention also provides a substrate onto which has been applied an ink composition of the invention to form letters, numbers or other symbols, or a graphic design on the substrate.

In a related aspect the present invention provides a substrate which comprises, typically thereon or within, at least one colloidal crystalline layer comprising monodisperse particles, which layer diffracts light having a wavelength in a range that corresponds to the wavelength of visible light, the crystalline layer forming letters, numbers or other symbols, or a graphic design on the substrate.

In the various aspects and embodiments described above, it is preferred that the lattice spacing in at least one axis is from about 350 nm to about 770 nm.

In the various aspects and embodiments described above, it is preferred that the particles are spherical.

Unless defined otherwise, all technical and scientific terms used herein have the same meaning as commonly understood by one of ordinary skill in the art.

The terms “colour” and “coloured” as used herein include “white”, and colouring of substrates and fibres includes “brightening”, for example the brightening of textiles.

The following examples serve to illustrate the invention without limiting the invention to them.

If not otherwise stated the percentages are weight percentages and the temperatures are given in Celsius.

### EXAMPLES

### Preparation of Ink Compositions

Several Ink compositions were prepared, comprised of silica-particles dispersed in ready to use base materials, which are commercial available.

### Synthesis of Silica-Particles

Monodispersed silica spheres were prepared following the well-known process by Stöber, Fink and Bohn (J. Colloid Interface Sci. 1968, 26, 62), as refined by Bogush, et. al. (J. Non-Crys. Solids 1988, 104, 95).

Briefly, the spheres were produced by hydrolytic polycondensation of tetraalkoxysilanes in an aqueous-ammoniacal medium, a sol of primary particles being produced first of all and then the SiO₂ particles obtained being brought to the desired particle size by continuous, controlled addition of tetraalkoxysilane (see U.S. Pat. No. 4,775,520). The final particle size obtained depends on the quantity of tetraalkoxysilane added in total. With this process it is possible to produce monodisperse SiO₂ spheres having average particle diameters of between 0.05 and 10 μm with a standard deviation of less than 7%. This procedure was used to prepare monodisperse silica spheres have average particle diameters of 250 nm, 330 nm, 410 nm or 500 nm.

The samples were then purified using the following method: The dispersion was centrifuged at 3000 rpm for 20 minutes to separate the solid from the liquid. The solid was redispersed in anhydrous ethanol to the original volume by mechanical stirring and ultrasonic treatment. This procedure was repeated several times.

The dispersion so prepared was then centrifuged and dried out, resulting a white powder, comprised of silica spheres and was used from now on as the solid component for following ink compositions.

### Example 1

Silica colloids in Clear Size base solution (Vitalac
710 ®; ICI Packaging Coatings)

| Ingredient | Amount [wt-%] |
|---|---|
| Silica powder (prep. as described above) | 55 |
| Diacetone Alcohol | 14 |
| 2-Butoxyethanol | 6 |
| Butanol | 10 |
| Ethylene Glycol | 11 |
| Mesitylene | 1.5 |
| Naphthalene | 0.5 |
| Epoxy Resin (epoxy constituents) | 2 |

This solvent-base ink composition, when applied to a substrate, especially black substrate forms a writing of iridescent metallic blue, which changes to green at a far viewing angle when using colloids of 250 nm.

### Example 2

Silica colloids in Overprint Varnish solution (Aquabase
105 ®; ICI Packaging Coatings)

| Ingredients | Amount [wt-%] |
|---|---|
| Silica powder (prep. as described above) | 55 |
| Propylene Glycol | 2.5 |
| 2-Butoxyethanol | 1.5 |
| 2-Dimethylaminoethanol | 1.5 |
| Ethylene Glycol | 2 |
| Formaldehyde | 0.5 |
| Epoxy Ester Resin (epoxy constituents) | 2 |
| Water | 35 |

This water-base ink composition, when applied to a substrate, especially black substrate forms a writing of iridescent metallic blue, which changes to metallic green at a far viewing angle when using colloids of 250 nm. The films are stable, when applying mechanical force compared to systems of the prior art (e.g. US20050137283 A1) without having epoxy resin incorporated.

Both experiments show that colourless colloids can be dispersed into both, solvent base and water base systems and show colour without the presence of carbon black when applied onto a substrate and in addition providing stability when curing agents are present in the liquid phase.

### Example 3

Silica colloids in Overprint Varnish in waterborne UV
resin LUX 3381 (Solvent-free UV-curable polyurethane-acrylic
dispersion from ALBERDINGK ®).

| Ingredients | Amount [wt-%] |
|---|---|
| Silica powder (prep. as described above) | 55 |
| Byk 028 | 2.5 |
| Irgacure 500 | 1.5 |
| 2-Dimethylaminoethanol | 1.5 |
| Ethylene Glycol | 2 |
| Aquazer 539 | 0.5 |
| ALBERDINGK ® LUX 3381 | 2 |
| Water | 35 |

This water-based UV-curable polyurethane-acrylic ink composition, when applied to a substrate, especially black substrate forms a writing of iridescent metallic blue, which changes to metallic green at a far viewing angle when using colloids of 250 nm. The films are stable, after pre-drying of 5-10 min at 50 C under normal light, but more stable after exposure to efficient UV lamps, usually medium pressure mercury lamps of at least 80 W/cm. (Hg 80 W/cm), is required.

When applying mechanical force the printing obtained by using formulation according to the present patent application are better than those of the prior art (e.g. US20050137283 A1) without waterborne UV activated resin incorporated.

### Example 4

Silica colloids in Overprint Varnish in waterborne UV
resin LUX 285 (Solvent-free UV-curable polyurethane-acrylic
dispersion from ALBERDINGK ®).

| Ingredients | Amount [wt-%] |
|---|---|
| Silica powder (prep. as described above) | 55 |
| Byk 346 | 1.5 |
| Irgacure 500 | 1.5 |
| 2-Dimethylaminoethanol | 1.5 |
| Dowanol DPM | 2 |
| Aquazer 539 | 0.5 |
| Ethylene Glycol | 1 |
| ALBERDINGK ® LUX 285 | 2 |
| Water | 35 |

This water-based UV-curable polyurethane-acrylic ink composition, when applied to a substrate, especially black substrate forms a writing of iridescent metallic blue, which changes to metallic green at a far viewing angle when using colloids of 250 nm. The films are stable, after pre-drying of 5-10 min. at 50 C, but more stable after exposure to efficient UV lamps, usually medium pressure mercury lamps of at least 80 W/cm. (Hg 80 W/cm), is required.

When applying mechanical force the printing obtained by using formulation according to the present patent application are better than those of the prior art (e.g. US20050137283 A1) without waterborne UV activated resin incorporated.

1. A printing formulation comprising
(i) monodisperse particles, and
(ii) at least one curing material, and
(iii) at least one initiator, and
(iv) at least one solvent.

2. A formulation according to claim 1, wherein the formulation comprises
0.01 wt-% to 70 wt-%, based on the total weight of the printing formulation, of monodisperse particles, and wherein the particles are capable of forming a colloidal crystal that diffracts light having a wavelength in a range that corresponds to the wavelength of visible light.

3. A formulation according to any of the claim 1, wherein the formulation comprises
0.01 to 30 wt-%, based on the total weight of the printing formulation, of monodisperse particles.

4. A formulation according to claim 1, wherein the formulation comprises
30 wt-% and 70 wt-%, based on the total weight of the printing formulation, of monodisperse particles.

5. A formulation according to claim 1 wherein the formulation is in the form of a liquid, a gel, a wax or a paste.

6. A formulation according to claim 1, wherein the monodisperse particles are spherical.

7. A formulation according to claim 1, wherein the monodisperse particles are inorganic particles selected from the group consisting of metal chalcogenide, metal pnictide, silica, metal and metal oxide particles.

8. A formulation according to any of claim 1, wherein the monodisperse particles are organic polymers selected from the group consisting of latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles.

9. (canceled)

10. (canceled)

11. A formulation according to claim 1, wherein the solvent comprises
water, and
optionally at least one organic solvent, selected from the group consisting of alcohols, esters, ketones, ethers and aliphatic and aromatic hydrocarbons having at least six carton atoms and mixtures thereof including refinery distillation products and by-products.

12. A formulation according to claim 1, wherein the
at least one solvent, is selected from the group consisting of alcohols, esters, ketones, ethers and aliphatic and aromatic hydrocarbons having at least six carton atoms and mixtures thereof including refinery distillation products and by-products.

13. (canceled)

14. A formulation according to claim 1, comprising
30 to 70 wt-%, based on the total weight of the printing formulation, of at least one solvent.

15. A formulation according to claim 1, comprising
70 to 99.99 wt-%, based on the total weight of the printing formulation of at least one solvent.

16. A formulation according to claim 1, wherein the curing material is chosen from the group consisting of polyester, vinylester, epoxy, phenolic, cyanate ester, polyurethane, bismaleimide, polyimide, epoxy acrylate, polyurethane acrylate, polyester acrylate, acrylated polyol and acrylated polyether compounds.

17. A formulation according to claim 1, comprising
0.01 to 15 wt-%, based on the total weight of the printing formulation, of at least one curing agent.

18. A formulation according to claim 1, wherein the initiator is chosen from the group consisting of peroxide or peroxide containing compounds, benzophenone and benzophenone derivatives, acetophenone and acetophenone derivatives, benzoin ether derivatives, thioxanthones derivatives α-hydroxyketone, phenylglyoxylate, benzyldimethyl-ketal, α-aminoketone, mono acyl phospine, bis acyl phosphine, phosphine oxide, metallocene, iodinum salts.

19. A formulation according to claim 1, comprising
0.005 to 10 wt-%, based on the total weight of the printing formulation, of at least one initiator.

20. A formulation according to claim 1, comprising 0.1 to 10 wt-%, based on the total weight of the printing formulation, of at least one auxiliary selected from the group consisting of pigments, fillers, extenders, degassing agents, dry flow agents, flow agents, matting agents, texturing agents, rheological additives, coalescence agents and waxes.

21. (canceled)

22. (canceled)

23. A method for printing a substrate comprising the step of applying to the substrate the formulation recited in claim 1, wherein the substrate is selected from the group consisting of fibre, hair, skin, nails, food material, stone, ceramic, glass, paper, fabrics, wood, leather and plastics.

24. (canceled)

25. A substrate which is printed with at least one formulation according to claim 1.

26. A substrate according to claim 25, chosen from the group consisting of fibre, skin, nails, food material, stone, ceramic, glass, paper, fabrics, wood, leather and plastics.
